(19) United States
(12) Patent Application Publication
(10) Pub. No.: US 2014/0262626 A1
(43) Pub. Date: Sep. 18, 2014

(54) Buckling-Resistant Lift Cylinders

(71) Applicant: THE RAYMOND CORPORATION, Greene, NY (US)

(72) Inventor: Joseph T. Yahner, Chenango Forks, NY (US)

(73) Assignee: THE RAYMOND CORPORATION, Greene, NY (US)

(21) Appl. No.: 13/804,722

(22) Filed: Mar. 14, 2013

(51) Int. Cl. B66F 9/22; B66F 9/08; B66F 9/07

(52) U.S. Cl. CPC B66F 9/22; B66F 9/07; B66F 9/08
USPC 187/229; 187/234

(57) ABSTRACT

A lift cylinder for a mast assembly of a vehicle and a vehicle implementing the same. The lift cylinder includes a cylinder housing with a piston received therein. The piston is movable along an axis of extension between an extended position and a retracted position. The piston is formed of a composite material having a reinforcement phase oriented along the axis of extension of the piston, thereby increasing the buckling resistance of the piston. This improved buckling resistance potential allows for increased lift cylinder extension and/or more compact lift cylinder design.

### CROSS-REFERENCE TO RELATED APPLICATIONS

Not applicable.

### BACKGROUND

This disclosure relates to improvements in pistons for lift cylinders, such as the lift cylinders in a mast assembly for a material handling vehicle.

Vehicles, such as material handling vehicles, are used to hoist and carry materials such as, for example, pallets or crates through a factory or a warehouse. One common material handling vehicle is a lift truck. Lift trucks typically have an upright telescopic mast attached to the forward end of the truck. The mast actuates a carriage, or forks, on which supporting materials can be lifted by the upward extension of the telescopic mast.

Such lift trucks often operate in tight spaces and are expected to safely lift objects to great heights. However, there are design trade-offs between providing short overall truck length and providing the high elevating heights.

Hence, there is a continuing need for mast assemblies that are capable of greater extension without significant modification to other parts of the vehicle.

### SUMMARY OF THE INVENTION

To date, the design of pistons for lift cylinders has been based on meeting the pressure or flow requirements of the hydraulic system. Accordingly, the pistons of conventional lift cylinders have been constructed of homogenous, isotropic materials such as standard and high strength steels. This reliance on high strength steels as construction materials for lift cylinders has led those in the industry to ignore the other limitations created by the use of these materials.

In this disclosure, modifications are proposed to the material structure of a piston for a lift cylinder that improves the buckling strength of the piston. This addresses a problem ignored by existing piston design and further enables an increased extension length for the lift cylinder without failure of the piston due to the piston exceeding a critical buckling strength.

An improved lift cylinder for a mast assembly of a vehicle, such as a material handling vehicle, is disclosed. The lift cylinder includes a cylinder housing with a piston received therein. The piston is movable along an axis of extension between an extended position and a retracted position. The piston comprises a composite material having a reinforcement phase oriented along the axis of extension, thereby increasing the buckling resistance of the piston (relative to a similar piston lacking the axially-oriented reinforcement phase).

The lift cylinder may be based on any of a number of different structural designs and may implement any of a number of piston types. For example, the piston may be a hollow piston or a solid piston.

The composite material may include a matrix material with the reinforcement phase dispersed therein such as, for example, a metal matrix composite material. In some forms, the matrix material may be a ferrous material including, for example, ferrous alloys, steel, or steel alloys including high strength steels. In one form, the reinforcement material may be a graphite-epoxy sub-matrix centrally disposed in the steel. In another form, the reinforcement phase may comprise tungsten carbide.

It is contemplated that in some forms, the reinforcement phase may be continuous from a first axial end of the piston to a second axial end of the piston using strands or other columns of the reinforcement material. In other forms, the reinforcement phase may be discontinuous from a first axial end of the piston to a second axial end of the piston (e.g., discontinuous whiskers or fibers).

The piston may include a sealing surface. In some instances, the reinforcement phase might provide discontinuous surface properties and pose problems in forming a reliable seal. Accordingly, a coating, such as a chrome-plating, may be applied over the composite material to provide the sealing surface.

It is contemplated that a lift cylinder of the types described above (and further described below) may be included in a vehicle. Thus, according to another aspect, a vehicle is disclosed including a mast assembly having one or more lift cylinders as recited herein. The mast assembly includes multiple sections that are extendable relative to one another via extension of the lift cylinder(s). The vehicle may be a lift truck, although other types of vehicles could also employ the improved lift cylinder with the modified piston.

By providing a piston having anisotropic properties in the direction of piston extension through use of an oriented reinforcement phase, the piston is provided with improved buckling resistance. Among other things, with this improved piston a lift cylinder can extend a greater distance (i.e., a mast assembly may be extended to greater heights by greater extension of the lift cylinder) without concern that the lift cylinder and piston, specifically, will fail as the result of buckling. Although the improvement of the material properties of the piston in the direction of extension comes at a cost of the materials properties in the directions perpendicular to the direction of extension, because the materials properties in these other directions are rarely design limiting, their compromise or reduction is tenable.

Moreover, even for systems in which an increase in extension length would not necessarily be advantageous, an improvement in buckling strength permits the use of higher pressures with smaller-sized lift cylinders. This reduction in lift cylinder size (e.g., diameter) means that the overall package size or footprint of the vehicle can be reduced while maintaining the original extension length.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a side elevation view of a lift truck.

FIG. 2 is a perspective view of the mast structure of the lift truck of FIG. 1.

FIG. 3 is a broken cross-sectional side view taken through a lift cylinder.

FIG. 4 is an exemplary cross section of a composite material for use in a lift cylinder comprising steel and a graphite-epoxy sub-matrix.

FIG. 5 is an exemplary cross section of a composite material for use in a lift cylinder comprising steel and tungsten carbide fibers.

### DETAILED DESCRIPTION OF THE PREFERRED EMBODIMENT

Referring first to FIG. 1, an exemplary lift truck includes a power unit 110 having an operator's compartment 112 located to the rear and a battery compartment 114 located at the forward end. The battery supplies power to a traction motor drive (not shown) which rotates a steerable drive wheel 116 to propel and steer the lift truck. A pair of laterally spaced baselegs 118 indirectly connects to and extends forward from the power unit 110, and each baseleg includes wheels 120 which support the truck. A mast assembly 122 connects to the front end of the power unit 110 and extends vertically upward therefrom. The mast assembly 122 supports a fork carriage 124 which is used to lift or elevate objects to various heights.

Now with additional reference to FIG. 2, the mast assembly 122 is comprised of three telescopic sections (although other numbers of sections might be used). These include a base section 126, an outer telescopic section 128, and an inner telescopic section 130. Rollers mounted to the sections 126, 128 and 130 enable those sections to slide with respect to each other to allow the mast assembly 122 to be raised and lowered.

The base section 126 is comprised of a pair of spaced, base rail members 132 and 134 connected together at their bottom ends by a base crosstie 136 and at their upper ends by a pair of crossties 138 and 140. The crossties 138 and 140 include a set of louvers which help to provide structural rigidity and bending resistance. The crosstie 140 may also serve to support a protective guard 142, as is illustrated in FIG. 1, above the operator. The base crosstie 136 attaches to the front of the power unit 110 and serves as a means for fastening the mast structure to the power unit 110.

The telescopic section 128 is comprised of a pair of spaced, upright mid rails 144 and 146 connected at their lower ends by a lower crosstie 148. An upper crosstie 150 extends rearward from the upper ends of the mid rails 144 and 146 and then laterally across the space between the mid rails 144 and 146 to maintain their parallel alignment. The rearward extending portions of the crosstie 150 also provide a connection point for a pair of main lift cylinders to be described in more detail below.

The inner telescopic section 130 is likewise comprised of a pair of spaced, upright top rails 152 and 154 connected at their lower ends by a lower crosstie 156 and connected at their upper ends by an upper crosstie 158.

Notably, the telescopic mast structure is raised and lowered by a pair of lift cylinders 172 and 174. The lower ends of the lift cylinders 172 and 174 are fastened to the base section 126 adjacent each end of the base crosstie 136. Piston rods 176 and 178 extend upward from respective main lift cylinders 172 and 174 and fasten to the upper crosstie 150 on the outer telescopic section 128. When the lift cylinders 172 and 174 are hydraulically operated in response to commands from the operator, the outer telescopic section 128 is lifted and lowered with respect to the base section 126 to extend and retract the mast 122.

Turning now to FIG. 3, an exemplary lift cylinder 210 is illustrated in greater detail which may be used in place as one of the main lift cylinders 172 or 174 in a lift truck as in FIGS. 1 and 2. In the particular embodiment illustrated, the lift cylinder 210 includes a cylinder housing 212 with a piston 214 in the form of a hollow piston received therein. The lift cylinder 210 axially extends from a bottom end 216 to a top end 218. At the bottom end 216 of the cylinder housing 210 there is an attached cylinder end cap 220. There is also a cylinder cushion 222 and a spring received within the bottom of the cylinder housing 212. The piston 212 extends from the head end of the cylinder housing 212 and has a piston head cap 224 attached thereto at the top end 218.

A hydraulic chamber 226 is defined in the piston 214 and the cylinder housing 212 which includes a bore section of the hollow body of the piston 214. Between the radially outward facing sealing surface 228 of the piston 214 and a seal gland 230 disposed at the head end of the cylinder housing 212, a series of seals 232 are provided in order to help prevent the leakage of any fluids or oils from the lift cylinder 210. Hydraulic fluid can be pumped into the hydraulic chamber 226 in order to move the piston 214 relative to the cylinder housing 212 (the point of hydraulic fluid entry is not shown in the illustration of FIG. 3). In FIG. 3, the lift cylinder 210 is shown in a retracted position in which the piston 214 is fully received in the cylinder housing 212 (or at least to the maximum extent possible). When the pressure in hydraulic chamber 226 is increased, the piston 214 is caused to extend upward from the cylinder housing 212 (i.e., the piston 214 is physically displaced upward relative to the cylinder housing 212) to an extended position in which the end-to-end length of the lift cylinder 210 is increased. When the lift cylinder 210 is installed in a mast assembly and caused to extend, this likewise causes the extension of the sections of the mast assembly and the attached carriage or forks. Upon the reduction of the pressure in the hydraulic chamber 226, the piston 214 retracts into the cylinder housing 214, shortening the end-to-end length of the lift cylinder 210.

Those having ordinary skill in the art will appreciate that this is but one exemplary type of piston design for one exemplary type of lift cylinder for one exemplary type of material handling vehicle and that the modifications to the piston structure disclosed herein would be equally applicable to other pistons for other lift cylinders that may be used in other types of vehicles. Accordingly, the vehicles, lift cylinders, and piston types are intended to be illustrative, but not limiting. For example, while a material handling vehicle in the form of a lift truck is illustrated, the disclosed and improved lift cylinder may be employed in other types of vehicles other than material handling vehicles. As still another example of a modification that may be made from the illustrated embodiments, it is contemplated that pistons involving this invention might have seal-to-bore designs and seal-to-rod designs.

To increase the buckling resistance of a piston in such a lift cylinder, the piston may be formed from a composite material having a reinforcement phase oriented along the axis of extension. Such an engineered composite material can increase the strength and stiffness of the piston in the axial direction.

In some forms of the composite, a ferrous continuous phase (the matrix) is combined with an oriented higher strength discontinuous phase (the reinforcement phase) in order to increase the modulus of elasticity or other materials properties in the axial direction of the finished piston component. The materials properties in this axial direction will be referred to by the term “E₁” in this document. Incorporation of an anisotropic material increases resistance to axial loading along the long axis of the lift cylinder (i.e., the axis of extension), while still maintaining sufficient resistance to bending and transverse loadings in directions perpendicular to the loading/extension direction.

To understand how and why such direction modification of the material improves buckling resistance, the following formulas and explanation are offered. Euler's formula for critical buckling resistance of a slender column is

$${F}_{CR} = \frac{{π}^{2} E I}{K {L}^{2}}$$

where F_{CR} is the critical load allowable, E is the modulus of elasticity, I is the moment of inertia, K is a factor accounting for the end conditions (e.g., are the ends fixed, rounded, or pivoted), and L is the length of the column.

For a column of solid circular cross section (such as a solid piston), the formula for moment of inertia is

$$I = \frac{π {D}^{4}}{64}$$

where D is the diameter of the circular cross section. To calculate the moment of inertia for a hollow cylindrical cross section (such as a hollow piston), the D⁴ term is changed to (Dₒ⁴-D_{I}⁴), where Dₒ is the cylinder outside diameter and D_{I} is the cylinder inside diameter.

Accordingly, returning to Euler's formula for critical buckling, for a lift cylinder column in which L and I are constant, increasing E proportionately increases F_{CR}. Given constant size and length constraints, this formula shows that increasing E in the direction of axial extension or loading will also increase the critical buckling strength resistance.

In order to increase E in this direction of axial extension or loading, a second reinforcement phase is introduced into the base or matrix material. In matrix-fiber composites in which the fibers are parallel with one another, the rule of mixtures for materials dictates that:

E₁=V_{f}E_{f}+VₘEₘ

where E₁ is a material property of the composite material in the direction parallel to the fibers (that is the primary direction of loading), V_{f} is the volume fraction of the fibers, E_{f} is the material property of the fibers, Vₘ is the volume fraction of the matrix, and Eₘ is the material property of the matrix. This equation can be used to provide an estimation of how the volume breakdown of the reinforcement fibers in the matrix affects the overall material properties of the material.

Because typical material handling equipment lift cylinder mounting results in floating housing designs that eliminate loading in the transverse or bending direction, increasing E₁ material properties may be achieved without severely compromising the E₂ and E₃ material properties (which are perpendicular to one another and to the E₁ loading direction). Put another way, any loss or degradation of the properties in the E₂ and E₃ directions as the result of preferentially increasing the properties in the E₁ direction are trivial and generally acceptable, since the E₂ and E₃ materials properties are not severely taxed under the applied loads.

Creation of this anisotropic composite material for the piston might be done in a number of ways which are now outlined. These exemplary embodiments of anisotropic composite materials are intended to be illustrative, but not limiting. Accordingly, other design geometries (i.e. piston or phase shapes or geometries or phase distributions) may be employed as well as other materials offering comparable properties.

First, with reference to FIG. 4, it is contemplated that a lined piston ram 310 (shown in cross section) may be formed having a core 312 of high modulus of elasticity and/or strength material (i.e., a reinforcing phase in the form of a sub-matrix) with a surrounding shell 314 of comparably lower strength matrix material. For example, in FIG. 4, the shell 314 may be formed from a steel having an elastic modulus of approximately 200 GPa, while the core 312 may be formed from a graphite-epoxy sub-matrix having an elastic modulus of approximately 300 GPa. There may be a central bore or opening 316 that provides a volume into which hydraulic fluid is received. In order to provide the desired cross-sectional area profile for the piston design, the shell 314 is sized to have an outer circumference 318 as desired and the core 312 is sized to provide an inner circumference 320 as desired. The interface 322 between the core 312 and the shell 314 may be positioned or shaped to provide the desired balance of volumes between each of the phases as well as to account for any compatibility of the materials.

While the outer circumference 318 may provide the sealing surface and not need to be modified, it is noted that, in some lift cylinder configurations or constructions, the inner circumference 320 of the bore may be a sealing surface. In this instance, it is contemplated that the surface may be coated or treated to provide the continuous surface qualities in order to establish and maintain a seal-to-bore interface if the reinforcement phase does not provide appropriate sealing qualities.

Moreover, it is contemplated that by redistributing the reinforcement phase to the outside (e.g., closer to the outer circumference 318) or the outside surface, the inside surface being steel to maximize E₂ and E₃ properties, the buckling resistance might be further optimized within the cross-sectional area available.

Likewise it is contemplated that the piston might be modified to be an MMC (metal matrix composite) material, with axial placement of high strength material reinforcement within the ferrous or steel matrix of the piston. It is contemplated that the reinforcement phase might be axially discontinuous (i.e., whiskers or fibers of reinforcing material that are generally oriented along the extension and loading axis, but that do not extend end-to-end in the piston) or might be continuous (i.e., strands or rods implanted within the matrix material that substantially extend from one end to the other end of the piston). In various forms, the matrix material may be a ferrous, steel, or high strength steel and the reinforcement phase may be a non-ferrous material or materials to resist loading in the axial direction.

As another example and with reference to FIG. 5, a solid cross section is shown of a solid piston 410. The piston 410 includes a steel matrix 412 (again, having an elastic modulus of approximately 200 GPa) and further includes axially-extending tungsten carbide strands as a reinforcement phase 414 (which have an elastic modulus of approximately 500 GPa). Preferably, the tungsten carbide strands run the axial length of the piston 410 so as to provide continuous reinforcement.

In such an arrangement as illustrated in FIG. 5, it is contemplated that the outer circumferential surface 416, which will also serve as a sealing surface, may be primarily steel but may have some amount of the reinforcement phase protruding therefrom if the strands of the reinforcement phase 414 are disposed at the outer circumferential surface 416. This could create a sealing surface that has various surface qualities that may present problems when forming a seal. In this instance, a coating, such as a chrome-plated coating, might be used to provide a homogeneous surface with a surface finish that provides acceptable sealing properties as well as an attractive and presentable finish quality.

Accordingly, various benefits may be derived from modification of the piston to be formed from a composite material with anisotropic materials properties. Among other things, the piston may be improved to provide greater unsupported extension length. Moreover, improving the axial properties of the piston allows systems designers to migrate toward the use of higher pressure systems (such as 5000 psi systems which are becoming more common in the industry), allowing higher loading capacities, without increasing the diameter of the piston. Likewise, existing systems might be made with smaller diameter pistons and higher pressures to handle the same loadings, therefore, smaller form lift cylinders which permit smaller headlength vehicles, machine packaging, and so forth in which the size reduction would otherwise present problems with buckling failure of the piston.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A lift cylinder for a mast assembly of a vehicle, the lift cylinder comprising a cylinder housing with a piston received therein in which the piston is movable along an axis of extension between an extended position and a retracted position, wherein the piston comprises a composite material having a reinforcement phase oriented along the axis of extension thereby increasing the buckling resistance of the piston.

2. The lift cylinder of claim 1, wherein the piston is a hollow piston.

3. The lift cylinder of claim 1, wherein the piston is a solid piston.

4. The lift cylinder of claim 1, wherein the composite material includes a matrix material with the reinforcement phase dispersed therein.

5. The lift cylinder of claim 4, wherein the matrix material is a ferrous material.

6. The lift cylinder of claim 5, wherein the matrix material is steel.

7. The lift cylinder of claim 6, wherein the reinforcement material is a graphite-epoxy sub-matrix centrally disposed in the steel.

8. The lift cylinder of claim 6, wherein the reinforcement phase comprises at least one of tungsten carbide and a high modulus material.

9. The lift cylinder of claim 1, wherein the composite material is a metal matrix composite material.

10. The lift cylinder of claim 1, wherein the reinforcement phase is continuous from a first axial end of the piston to a second axial end of the piston.

11. The lift cylinder of claim 1, wherein the reinforcement phase is discontinuous from a first axial end of the piston to a second axial end of the piston.

12. The lift cylinder of claim 1, wherein the piston includes a sealing surface.

13. The lift cylinder of claim 12, wherein a coating is applied over the composite material to provide the sealing surface.

14. The lift cylinder of claim 12, wherein a chrome-plated coating provides the surface seal.

15. A vehicle comprising a mast assembly having at least one lift cylinder as claimed in claim 1, wherein the mast assembly includes multiple sections that are extendable via extension of the at least one lift cylinder.

16. The vehicle of claim 15, wherein the vehicle is a lift truck.
